(19) United States
(12) Patent Application Publication
(10) Pub. No.: US 2010/0152091 A1
(43) Pub. Date: Jun. 17, 2010

(54) CLEANING COMPOSITION

(76) Inventor: Arshad Malik, Dublin, CA (US)

Correspondence Address: KLARQUIST SPARKMAN, LLP, 121 SW SALMON STREET, SUITE 1600, PORTLAND, OR, 97204, US

(21) Appl. No.: 12/733,142

(22) PCT Filed: Aug. 14, 2007
(86) PCT No.: PCT/US07/18104

§ 371 Date: Feb. 11, 2010

(51) Int. Cl. C11D 3/48; C11D 3/37

(52) U.S. Cl. 510/383; 510/470; 510/382

(57) ABSTRACT

A neutral composition comprising an alkyl polyglucoside, a fatty alcohol polyglycol ether, xanthan gum, a biocide, and citric acid is disclosed which is useful for cleaning articles in need thereof. In exemplary embodiments the disclosed composition comprises an alkyl polyglucoside composition that is a mixture of C8/10 and C10/16 alkyl polyglucosides having an average degree of polymerization of about 1.5, a C12/16 fatty alcohol polyglycol ether 7 EO, xantham gum, a biocide composition comprising a mixture of isothiazolone compounds, and citric acid and has a pH of about 6.5-7.5.

### FIELD

This disclosure relates to neutral cleaning formulations containing a surfactant system comprising polyglucosides and fatty alcohol polyglycol ethers, in combination with xanthan gum, a biocide, and citric acid, as well as the use of such formulations to clean.

### BACKGROUND

There are numerous cleaning compositions already known that are effective against many varieties of soils. Many such cleaning compositions contain potentially harmful or environmentally damaging ingredients or are at such a high pH that they are irritating to the skin. Typically, however, in order to achieve effective cleaning, particularly of grease, such caustic cleaners must be used. Thus, it would be advantageous to develop a cleaning composition that includes less environmentally damaging and dangerous ingredients that would be an effective cleaner at a neutral pH.

Alkyl polyglucosides and fatty alcohol polyglycol ethers are both classes of non-ionic surfactants that are generally considered relatively environmentally friendly due to their biodegradability and because they may be produced from natural substances. Cleaning compositions including alkyl polyglucosides and fatty alcohol polyglycol ethers are disclosed in Behler et al. (U.S. Pat. No. 5,599,476 (1997)). Schmid et al. (U.S. Pat. No. 5,866,530 (1999)) disclose a water free compound for use in making cleaning formulations comprising an alkyl oligoglycoside and an alkyl polyalkylene glycol ether. Gross et al. (U.S. Pat. No. 5,877,142 (1999)) also disclose a surfactant composition containing an alkyl polyglucoside and a fatty alcohol polyglycol ether. (C5:L23-36.) In addition, Van Buskirk et al. (U.S. Pat. No. 5,576,284 (1996)) disclose examples of a cleaning composition comprising an alkyl polyglucoside and a fatty alcohol polyglycol ether.

Despite the environmental benefits from the incorporation of alkyl polyglucosides and fatty alcohol polyglycol ethers into cleaning compositions and the existence of known cleaning compositions incorporating such surfactants, caustic cleaners are still generally considered more effective in cleaning and necessary to remove heavy soils such as grease.

### SUMMARY

It has been discovered that, surprisingly, a neutral cleaning formulation comprising an alkyl polyglucoside, a fatty alcohol polyglycol ether, xanthan gum, a biocide, and citric acid exhibits a cleaning effectiveness essentially equal to or better than a caustic cleaning formulation. Accordingly, disclosed herein is a neutral cleaning formulation comprising an alkyl polyglucoside, a fatty alcohol polyglycol ether, xanthan gum, a biocide, and citric acid as well as methods of making and using such a formulation.

The foregoing and other objects, features, and advantages of the disclosed cleaning formulation will become more apparent from the following detailed description.

### DETAILED DESCRIPTION

As used herein alkyl polyglucosides are compounds having formula I: R₁O(R₂O)_{b}(Z)ₐ, wherein R₁ is a alkyl radical, having from about 1 to about 30 carbon atoms; R₂ is an alkylene radical having from 2 to 4 carbon atoms; Z is a saccharide residue having 5 or 6 carbon atoms; b is a number having a value from 0 to about 12; and a is a number having a value from 1 to about 6 (the degree of polymerization). Due to the method by which they are synthesized, alkyl polyglucosides are generally present as mixtures of alkyl polyglucosides having varying amounts of carbon atoms in the alkyl radical and varying degrees of polymerization. Thus, when referring to alkyl polyglucosides, the alkyl radical is generally referred to as having a range of carbon atoms (e.g., C8/16 referring to a range of alkyl radicals having from 8-16 carbon atoms) and the degree of polymerization is generally referred to as the average degree of polymerization of the mixture.

Alkyl polyglucosides suitable for use in the disclosed cleaning formulation include those having the formula I wherein Z is a glucose residue, b is zero, R1 is an alkyl group that contains 8 to 16 carbon atoms, and the average value of a is about 1-2. Such alkyl polyglucosides are commercially available, for example, as GLUCOPON branded alkyl polyglucoside compositions from Cognis Corporation. Examples of such commercially available alkyl polyglucoside compositions include compositions where the alkyl polyglucoside forms 100% of the composition and compositions where the alkyl polyglucoside forms less than 100% of the composition and include but are not limited to:

1. GLUCOPON 425 N—an alkyl polyglucoside composition in which the alkyl group contains 8 to 16 carbon atoms (and is a mixture of C8/10 and C10/16 alkyl polyglucosides) and having an average degree of polymerization of 1.5. GLUCOPON 425 N comprises about 50% alkyl polyglucosides (such as 48%-52% according to the supplier's specification), about 0.012% of a preservative such as glutaraldehyde, up to 3% ash, up to 4% of a colorant, with the rest of the alkyl polyglucoside composition comprising water, e.g., about 50%, such as about 48%-52%.

2. GLUCOPON 625—an alkyl polyglucoside composition in which the alkyl groups contain 12 to 16 carbon atoms and having an average degree of polymerization of 1.6.

3. GLUCOPON 600—an alkyl polyglucoside composition in which the alkyl groups contain 12 to 16 carbon atoms and having an average degree of polymerization of 1.4.

As used herein a fatty alcohol polyglycol ether has formula II: R₃—O—(CH₂CH₂O)ₙH wherein R₃ is an alkyl radical containing 6 to 24 carbon atoms, and n is a number from 1 to 50 (with this number also referring to the number of ethylene oxide units (“EO”)). Such compounds are prepared by ethoxylating the corresponding fatty alcohols. Suitable fatty alcohols include coconut fatty alcohol, tallow fatty alcohol, lauryl alcohol, myristyl alcohol and oleyl alcohol. As with the alkyl polyglucoside, a fatty alcohol-polyglycol ether generally contains a mixture of fatty alcohol polyglycol ethers which may also have varying degrees of ethoxylation. Thus, fatty alcohol polyglycol ethers are generally referred to by the range of carbon atoms in the alkyl radical as, e.g., C12/16 (referring to a mixture of fatty alcohol polyglycol ethers containing between 12 to 16 carbon atoms). In such mixtures the degree of ethoxylation of each fatty alcohol polyglycol ether may also vary. Thus, the EO number in such a mixture is the average degree of ethoxylation.

In certain embodiments of the disclosed cleaning formulation, R3 in the fatty alcohol polyglycol ether is an alkyl radical having from 8-20 carbon atoms, or more specifically from 10-18 carbon atoms. In a particular embodiment R3 is an alkyl radical containing 12-16 carbon atoms. The degree of ethoxylation in certain embodiments range from 2-20 EO, or more specifically from 2-10 EO. In more specific embodiments the degree of ethoxylation of the fatty alcohol polyglycol ether ranges from 6-8 EO and, in a particular embodiment is about 7 EO.

A suitable fatty alcohol polyglycol ether is a C12/C16 fatty alcohol polyglycol ether (7 EO) available in a commercial fatty alcohol polyglycol ether composition under the name GENAPOL LA 070 from Clariant (which comprises about 100% of the fatty alcohol polyglycol ether, but may in certain cases include about 99.9% fatty alcohol polyglycol ether and up to about 0.1% water). Clariant also markets other suitable fatty alcohol polyglycol ethers compositions under the name GENAPOL, such as GENAPOL LA 79 which is a C12/C16 fatty alcohol polyglycol ether (7 EO) (which comprises about 90% of the fatty alcohol polyglycol ether) and GENAPOL 26-L-45 a C12-16 fatty alcohol polyglycol ether (6.3 EO).

Xanthan gum is a polysaccharide polymer produced by a process involving fermentation of glucose or sucrose by the Xanthomonas campestris bacterium. It is commercially available from CP Kelco under the name KELZAN® T, which is a clarified version of xanthan gum. In place of or in addition to xanthan gum, the cleaning formula may include other suitable naturally occurring polysaccharide polymers such guar gum or locust bean gum, or derivatives thereof, or mixtures thereof.

The biocide is generally incorporated into the cleaning formulation as a biocide composition because most commercially available biocides are sold in a form where the biocide comprises only a percentage, such as 0.5%-2% (by weight) of the commercially available composition. However, the biocide can also be incorporated into the cleaning formulation on its own rather than in a biocide composition. As used herein a biocide composition includes compositions where 100% of the composition is one or more biocides as well as compositions in which one or more biocides comprise less than 100% of the composition. Suitable biocide compositions include any of those comprising a mildewstat or bactoristat. In particular, suitable biocide compositions include those where the biocide comprises an isothiazolone compound or a derivative thereof. Such biocide compositions include those marketed under the name KATHON, including KATHON GC, which comprises a 5-chloro-2-methyl-4-isothiazolin-3-one, KATHON ICP, which comprises a 2-methyl-4-isothiazolin-3-one, and KATHON GC-ICP, which comprises a blend of 5-chloro-2-methyl-4-isothiazolin-3-one and 2-methyl-4-isothiazolin-3-one. In certain embodiments the biocidal compound of the biocide composition comprises about 0.1% to 5% of the biocide composition, more specifically, in some cases, about 0.5% to 2.5% of the biocide composition and, in particular cases, comprise about 1.5% of the biocide composition. The remainder of the biocide composition in some cases comprises water and/or stabilizers, such as metal salts, for example magnesium salts. KATHON GC-ICP, for instance, comprises about 1.5% of a mixture of 5-chloro-2-methyl-4-isothiazolin-3-one and 2-methyl-4-isothiazolin-3-one, about 23-25% magnesium salts, and the remainder water.

Additional exemplary biocides include methyl, ethyl and propyl parabens, short chain organic acids (such as acetic, lactic and glycolic acids), bisguanidine compounds, and other compounds having mildewstat and/or bacteriostat functionality.

Citric acid is an organic acid found naturally in citrus fruits (also known as 2-hydroxypropane-1,2,3-tricarboxylic acid). It is commercially available from numerous suppliers. In the disclosed cleaning formulation, the citric acid is added to the formulation until the pH of the formulation is about 6.5-7.5, e.g., pH 7. The pH of the formulation can be easily measured with a pH meter so that one can determine whether additional citric acid should be added.

The disclosed cleaning formulation may also include additional and typical additives such as colorants, preservatives, e.g., glutaraldehyde, thickeners, and pH adjusting agents such as ash, or acids. In some cases these additives are present due to their incorporation in the commercially available formulations of alkyl polyglucosides, fatty alcohol polyglycol ethers, xanthan gums, biocides, and citric acids that can be used in making the disclosed cleaning formulation. For example, the GLUCOPON 425 N alkyl polyglucoside composition used in certain exemplary embodiments of the disclosed cleaning formulation includes, in addition to alkyl polyglucosides, ash, glutaraldehyde, and colorant. In the disclosed embodiments, such additives generally comprise only a small percentage of the respective ingredient.

The disclosed cleaning formulation comprises an alkyl polyglucoside, a fatty alcohol polyglycol ether, xanthan gum, a biocide, and citric acid. In some cases the cleaning formulation further comprises water, such as deionized water, in addition to any water present in any of the aforementioned ingredients. In certain embodiments the cleaning formulation is formulated as a concentrated cleaning formula, which is usually, but not necessarily, diluted further with additional water or other suitable dilutant prior to use. In certain embodiments of such a concentrated cleaning formula these ingredients are present in the amounts noted in Table 1.

TABLE 1

| | Percentage of total weight of the |
|---|---|
| | cleaning formulation (excepting the |
| Ingredient | citric acid) |
| Water | 50%-80%, e.g., 60%-70%, more |
| | specifically 60%-65%, and in a certain |
| | embodiment about 64.4% |
| alkyl polyglucoside | 10%-40%, e.g., 20%-30%, more |
| | specifically 20%-25%, and in a certain |
| | embodiment about 23.7% |
| fatty alcohol polyglycol ether | 1%-20%, e.g., 5%-15%, more |
| | specifically 10%-15%, and in a certain |
| | embodiment about 11.8% |
| xanthan gum | .01%-2%, e.g., .1%-1%, more |
| | specifically .01%-.05%, and in a |
| | certain embodiment about 0.05% |
| biocide composition | .01%-2%, e.g., .1%-1%, more |
| | specifically .01%-.05%, and in a |
| | certain embodiment about 0.05% |
| citric acid | Sufficient to adjust the pH of the |
| | formulation to about pH 7 |

The disclosed cleaning formulation also includes more dilute formulations in which, for example, the ratio of the concentrated cleaning formulation described in Table 1 above to an additional neutral dilutant (such as neutral water) is about 0.5:128-6:128, such as 1:128-4:128, and more specifically 1.5:128-3:128, such as 2:128. The disclosed cleaning formulation in the form of the concentrated cleaning formulation described in Table 1 diluted in the ratio of 2:128 with water has proven to be a particularly effective cleaning formulation, as discussed below in Examples II-III. The percentages of the ingredients other than the citric acid are as noted in Table 2 below for such a cleaning formulation comprising the concentrated cleaning formulation from Table 1 diluted with water in the ratio 2:128.

TABLE 2

| | Percentage of total weight of the |
|---|---|
| | cleaning formulation (excepting the |
| Ingredient | citric acid) |
| water | about 99%-99.83% |
| alkyl polyglucoside | about .15%-.62%, e.g., .31%-.46%, |
| | more specifically .31%-.38%, and in a |
| | certain embodiment about .36% |
| fatty alcohol polyglycol ether | about .02%-.31%, e.g., .08%-.23%, |
| | more specifically .15%-.23%, and in a |
| | certain embodiment about .18% |
| xanthan gum | about .0002%-.031%, e.g., .002%-.02%, |
| | more specifically .0002%-.0008%, and |
| | in a certain embodiment about 0.0008% |
| biocide composition | about .0002%-.031%, e.g., .002%-.02%, |
| | more specifically .0002%-.0008%, and |
| | in a certain embodiment about 0.0008% |

The cleaning formulation is prepared simply by mixing together the alkyl polyglucoside, fatty alcohol polyglycol ether, xanthan gum, biocide, citric acid and any additional water in a suitable mixing vessel. This may be done in any order. However, as the citric acid is used to adjust the pH of the cleaning formulation to about pH 6.5-7.5, the other ingredients are typically mixed together before the citric acid is mixed in with them. It is then added to the other ingredients in a stepwise fashion with pH measurements taken in between the addition of portions of citric acid to the mixture until the pH of the cleaning formulation is about 7, e.g., pH 6.5-7.5. If a concentrated version of the disclosed cleaning formulation is diluted to form a diluted version of the disclosed cleaning formulation, a neutral dilutant may used, such as neutral water, so that additional citric acid need not be added to the formulation to maintain the neutral pH.

In use, the disclosed cleaning formulation is applied to an article to be washed and then rinsed off with water or another suitable rinsing agent. In certain embodiments of methods of using the cleaning formulation, the cleaning formulation is first diluted with water or another suitable dilutant such that the ratio of the pre-diluted cleaning formulation to the amount of dilutant can be expressed, e.g., as 2 ounces per gallon (referring to a dilution of 2 ounces of the pre-dilution cleaning formulation into a gallon of dilutant).

Accordingly, kits containing the disclosed cleaning formulation with written instructions for diluting the cleaning formulation as it is provided in the kit to a particular ratio are disclosed. Such kits include, for example, a concentrated version of the disclosed cleaning formulation, such as the embodiments described in Table 1 above or in Example 2 below and instructions to dilute the concentrated cleaning formulation with water or another suitable dilutant in a ratio such as about 0.5:128-6:128, such as 1:128-4:128, and more specifically 1.5:128-3:128, such as 2:128.

In some methods of using the cleaning formulation, after the cleaning formulation is applied to the article to be washed, manual energy is applied to the article and the cleaning formulation, e.g., by scrubbing with a sponge, to increase the cleaning effectiveness of the cleaning formulation. The cleaning formulation can be applied to the article to be washed by any number of suitable means that result in the cleaning formulation contacting the article to be washed, including by pouring the cleaning formulation onto the article or spraying the formulation onto the article from a spray bottle.

### Example I

This is an example of the disclosed cleaning formulation in the form of a concentrated cleaning formulation. This embodiment of the cleaning formulation comprises the ingredients listed in Tables 3-4.

TABLE 3

| | Percentage of total weight of the |
|---|---|
| | cleaning formulation (excepting the |
| Ingredient | citric acid) |
| water | 64.4% (including the water present in |
| | the alkyl polyglucoside composition |
| | used in this embodiment) |
| alkyl polyglucoside | 23.7% |
| fatty alcohol polyglycol ether | 11.8% |
| xanthan gum | 0.05% |
| biocide | 0.05% |
| citric acid | Sufficient to adjust the pH of the |
| | formulation to about pH 7 |

In particular, this embodiment comprises the specific ingredients listed in Table 4.

TABLE 4

| | Percentage of total weight of the |
|---|---|
| | cleaning formulation (excepting |
| Ingredient | the citric acid) |
| water | 40.7% (not including the water |
| | present in the other ingredients) |
| GLUCOPON 425 N - an alkyl | 47.4% |
| polyglucoside composition comprising | |
| a mixture of about 50% C8/16 alkyl | |
| polyglucosides having an average | |
| degree of polymerization of about 1.5 | |
| and about 50% water (this water is in | |
| addition to the amount of water noted | |
| above) | |
| GENAPOL LA 070 C12/C16 fatty | 11.8% |
| alcohol polyglycol ether (7 EO) | |
| KELZAN T xanthan gum | 0.05% |
| KATHON GC-ICP - a biocide | 0.05% |
| composition comprising about 1.5% of | |
| a blend of 5-chloro-2-methyl-4- | |
| isothiazolin-3-one and 2-methyl-4- | |
| isothiazolin-3-one and further | |
| comprising magnesium salts and water | |
| citric acid | Sufficient to adjust the pH of the |
| | formulation to about pH 7 |

### Example II

This example describes the surprising results obtained in a comparison test of the disclosed cleaning formulation described in Example I against a cleaning composition having a pH of about 10.5-11.3 comprising about 61% water and about 27.5% of a mixture of alcohol ethoxylate surfactants (“Product B”).

The comparison test was conducted with 11 participants blinded to the product that they were using. Participants were asked to use both the disclosed cleaning formulation (the embodiment disclosed in Example I) and Product B in cleaning various types of soil. They were instructed to dilute both products with water at 2 oz./gallon (a ratio of 2:128).

Though one would have expected the caustic Product B to be more effective, the disclosed cleaning formulation outperformed Product B on 10 out of 12 measures and performed equally on the additional 2 measures.

Tables 5-6 provide the results from the participants' comparison of the 2 products with respect to the ease of cleaning and effectiveness in cleaning for the following surfaces:

TABLE 5

| | Cleaning | | |
|---|---|---|---|
| | was | Cleaning was easier | Both products |
| | easier with | with the disclosed | were equally |
| Surface | Product B | cleaning formulation | easy for cleaning |
| Oil on driveways | 0.0% | 40.0% | 60.0% |
| Garage floors | 16.7% | 50.0% | 33.3% |
| Greasy BBQ grills | 28.6% | 28.6% | 42.9% |
| Engines | 0.0% | 75.0% | 25.0% |
| Greasy oven racks | 16.7% | 50.0% | 33.3% |
| Greasy stove racks | 25.0% | 37.5% | 37.5% |

TABLE 6

| | | | Both |
|---|---|---|---|
| | | The disclosed | products |
| | Product B was | cleaning formulation | were equally |
| Surface | more effective | was more effective | effective |
| Oil on driveways | 0.0% | 60.0% | 40.0% |
| Garage floors | 16.7% | 50.0% | 33.3% |
| Greasy BBQ grills | 28.6% | 28.6% | 42.9% |
| Engines | 0.0% | 100.0% | 0.0% |
| Greasy oven racks | 28.6% | 42.9% | 28.6% |
| Greasy stove racks | 25.0% | 37.5% | 37.5% |

### Example III

This example describes further surprising results obtained in a comparison test of the disclosed cleaning formulation described in Example I against Product B of Example II and another high pH commercially available cleaning product called EASY OFF BAM Cleaner/Degreaser.

Performance of the cleaning products compared was based on ASTM D-4488, for greasy soil (A2) and grimy soil (A3). Also evaluated was the ability of the products to remove different types of burned-on food from stainless steel. Table 7 provides the results of the following tests:

A. Hard Surface/General Purpose Cleaning ASTM D4488-A3 (Grimy Soil)

The reflectance of designated test areas of clean 12″×12″ pieces of Armstrong Excelon, Imperial Texture, Pattern 51899, vinyl composition tile was measured. Iron oxide pigmented soil, specified in ASTM D-4488, Appendix 3, was applied to the 12″ square tile. The tiles were allowed to age at room temperature for one hour and then baked at 100° C. for 30 minutes. After baking, the tiles were allowed to cool. The 12″ square was then cut into 4″×4″ squares and the reflectance was measured in the test area of each 4″ square tile. The tiles were allowed to sit over night, at ambient temperature, before testing.

The cleaning products tested were diluted with Toledo tap water (68-70° F.) in the ratio indicated Table 7 (or not diluted in the case of EASY OFF BAM).

A soiled test tile was mounted in the tray of a Gardner Straight-Line Washability Apparatus, and a damp sponge placed in the carriage. 2 grams of the applicable test product was applied to the tile, allowed a 30 second soak, then the test tile was scrubbed with the sponge for ten cycles and then rinsed under water. After the test tile was dry the reflectance was measured again.

The percent soil removed (SR) was calculated using the formula: SR=100(Lc−Ls)/(Lo−Ls), where Lo is the reflectance of the unsoiled tile, Ls is the reflectance after soiling, and Lc is the reflectance after cleaning.

B. Hard Surface/General Purpose Cleaning ASTM D4488-A2 (Greasy Soil)

The reflectance of designated test areas of clean 4″×4″ pieces of white, flat painted wall board tiles was measured. Greasy soil, as specified in ASTM D-4488, Appendix 2, was applied to the tiles. The tiles were allowed to age at room temperature for one hour and then the excess soil was removed. The reflectance was then measured in the soiled area and the tiles were allowed to sit over night, at ambient temperature, before testing.

The tested products were in the ratio indicated Table 7 (or not diluted in the case of EASY OFF BAM), and the soil removal testing and calculations performed as above for grimy soil.

C. Hard Surface Cleaning (Burned-On Food, Stainless Steel CSPA DCC-12)

Stainless steel panels acquired from Q-Panel, Lab Products, were soiled with soil made according to the CSPA DCC-12 Methodology. The soil consisted of: ground beef, cheddar cheese, whole milk, sugar, cherry juice, tapioca, egg, flour and tomato juice. Panels were then baked for 45-minutes at 200° C. The panels were allowed to cool overnight. The reflectance of each panel was measured before and after soiling.

The soiled panel was placed into the tray of the Gardner Straight-Line Washability Apparatus with the appropriate spacers. Three grams of the cleaning product being tested at the dilution noted in Table 7 (or not diluted in the case of EASY OFF BAM) was sprayed onto the surface of the panel and allowed to soak for 30 minutes. A tap water dampened sponge was then placed into the carriage. The panel was then scrubbed for twenty (20) cycles using the damp sponge. The panel was then immediately rinsed under a stream of water from the tap. Panels were allowed to dry vertically at ambient temperatures. After they dried, the reflectance was measured.

The percent soil removed was calculated as above.

D. Hard Surface Cleaning (Barbeque Grill Soil, Stainless Steel)

Stainless steel panels acquired from Q-Panel, Lab Products, were soiled with soil made up of a mixture of Molasses, Coconut Oil, Lecithin, Beef Fat and Parmesan Cheese. Panels were then baked for 45-minutes at 200° C. Panels were allowed to cool overnight. The reflectance of each panel was measured before and after soiling.

The tested products were diluted at the ratio indicated in Table 7 (or not diluted in the case of EASY OFF BAM), and the soil removal testing and calculations were performed as above for burned on food.

E. Hard Surface/General Purpose Cleaning (Kitchen Floor Soil—Food)

The reflectance of designated test areas of clean 12″×12″ pieces of Armstrong Excelon, Imperial Texture, Pattern 51899, vinyl composition tile was measured. Spaghetti was applied to the 12″ square tile. The tiles were allowed to age at room temperature overnight. The 12″ square was then cut into 4″×4″ squares and the reflectance was measured in the test area of each 4″ square tile.

The tested cleaning products were diluted in the ratio indicated Table 7 (or not diluted in the case of EASY OFF BAM), and the soil removal testing and calculations performed as above for grimy and greasy soil in part A-B above.

TABLE 7
Soil Removal (%) of the Various Tested Soils by the Disclosed
Cleaning Formulation, Product B, & EASY OFF BAM

| | | Disclosed Cleaning | | | | EASY OFF | |
|---|---|---|---|---|---|---|---|
| | | Formulation | | | Product B | BAM | |
| Substrate | Soil | 2 oz/Gal | 4 oz/Gal | 6 oz/Gal | 2 oz/Gal | Not diluted | Sig. Dif. |
| Flat, | ASTM | 4.9 | 5.0 | 6.6 | 5.7 | 44.6 | 1.7 |
| White | D4488-A2 | | | | | | |
| Painted | (Greasy | | | | | | |
| Wallboard | Soil) | | | | | | |
| Vinyl | Spaghetti | 52.3 | 54.9 | 58.6 | 56.1 | 61.8 | 7.3 |
| Composite | Sauce | | | | | | |
| Flooring | (Kitchen | | | | | | |
| | Floor Soil) | | | | | | |
| Vinyl | ASTM | 25.5 | 32.2 | 30.9 | 25.2 | 59.1 | 9.1 |
| Composite | D4488-A3 | | | | | | |
| Flooring | (Grimy Soil) | | | | | | |
| Stainless | BBQ Grill | 0.3 | 0.0 | 0.1 | 0.2 | 0.3 | 0.8 |
| Steel | | | | | | | |
| Stainless | CSPA DCC- | 1.0 | 0.9 | 0.3 | 1.5 | 0.2 | 2.5 |
| Steel | 12 Oven | | | | | | |
| | Soil (Burned | | | | | | |
| | on Food) | | | | | | |

| | | | | | |
|---|---|---|---|---|---|
| Overall Total | 84.0 | 93.0 | 96.5 | 88.7 | 166.0 |

As can be seen from the results provided in Table 7, the disclosed cleaning formulation performed essentially equivalent to the caustic cleaner, Product B, at the same dilution ratio of 2 oz. per gallon. This is surprising because one would expect the caustic cleaner to perform much better than the neutral disclosed cleaning formulation. Though the disclosed cleaning formulation did not perform as well as the caustic cleaner EASY OFF BAM, this is not unexpected because the EASY OFF BAM product was not diluted.

### Example IV

Provided in the tables below are additional examples of the disclosed cleaning formulation.

TABLE 8

| | Percentage of |
|---|---|
| | total weight of |
| | the cleaning formulation |
| Ingredient | (excepting the citric acid) |
| Water | 80% |
| alkyl polyglucoside - such as a mixture of | 14.98% |
| C8/16 alkyl polyglucosides having an average | |
| degree of polymerization of about 1.5 | |
| fatty alcohol polyglycol ether - such as a | 5% |
| C12/C16 fatty alcohol polyglycol ether (7 EO) | |
| xanthan gum | .01% |
| biocide composition - such as a composition | .01% |
| comprising 1.5% of a blend of a blend of 5- | |
| chloro-2-methyl-4-isothiazolin-3-one and 2- | |
| methyl-4-isothiazolin-3-one | |
| citric acid | Sufficient to adjust the |
| | pH of the formulation to |
| | about pH 7 |

TABLE 9

| | Percentage of |
|---|---|
| | total weight of |
| | the cleaning formulation |
| Ingredient | (excepting the citric acid) |
| Water | 50% |
| alkyl polyglucoside - such as a mixture of | 40% |
| C8/16 alkyl polyglucosides having an average | |
| degree of polymerization of about 1.5 | |
| fatty alcohol polyglycol ether - such as a | 9.8% |
| C12/C16 fatty alcohol polyglycol ether (7 EO) | |
| xanthan gum | .1% |
| biocide composition - such as a composition | .1% |
| comprising 1.5% of a blend of a blend of 5- | |
| chloro-2-methyl-4-isothiazolin-3-one and 2- | |
| methyl-4-isothiazolin-3-one | |
| citric acid | Sufficient to adjust the |
| | pH of the formulation to |
| | about pH 7 |

TABLE 10

| | Percentage of |
|---|---|
| | total weight of |
| | the cleaning formulation |
| Ingredient | (excepting the citric acid) |
| Water | 60% |
| alkyl polyglucoside - such as a mixture of | 30% |
| C8/16 alkyl polyglucosides having an average | |
| degree of polymerization of about 1.5 | |
| fatty alcohol polyglycol ether - such as a | 9.9% |
| C12/C16 fatty alcohol polyglycol ether (7 EO) | |
| xanthan gum | 0.05% |
| biocide composition - such as a composition | 0.05% |
| comprising 1.5% of a blend of a blend of 5- | |
| chloro-2-methyl-4-isothiazolin-3-one and 2- | |
| methyl-4-isothiazolin-3-one | |
| citric acid | Sufficient to adjust the |
| | pH of the formulation to |
| | about pH 7 |

In view of the many possible embodiments to which the principles of the disclosed cleaning formulation and methods of use may be applied, it should be recognized that the embodiments illustrated above are only preferred examples of the disclosed cleaning formulation and methods of use and should not be taken as limiting the scope of the invention claimed below. Rather, the scope of the invention is defined by the following claims. I therefore claim as my invention all that comes within the scope and spirit of these claims.

I claim:

1. A cleaning composition comprising:
one or more alkyl polyglucosides;
one or more fatty alcohol polyglycol ethers;
xanthan gum;
a biocide composition comprising one or more biocides; and
citric acid, wherein the cleaning composition has a pH of 6.5-7.5.

2. The cleaning composition of claim 1, wherein the one or more alkyl polyglucosides comprises alkyl radicals that contain 8 to 16 carbon atoms and have an average degree of polymerization of 1-2.

3. The cleaning composition of claim 2, wherein the one or more alkyl polyglucosides comprises a saccharide residue that is a glucose residue.

4. The cleaning composition of claim 3, wherein the one or more alkyl polyglucosides have an average degree of polymerization of 1.5.

5. The cleaning composition of claim 4, wherein the one or more alkyl polyglucosides comprises a mixture of C8/10 alkyl polyglucosides and C10/16 alkyl polyglucosides.

6. The cleaning composition of claim 5, wherein the one or more fatty alcohol polyglycol ethers comprises alkyl radicals that contain 12 to 16 carbon atoms.

7. The cleaning composition of claim 6, wherein the one or more fatty alcohol polyglycol ethers comprises a C12/16 fatty alcohol polyglycol ether.

8. The cleaning composition of claim 7, wherein the C12/16 fatty alcohol polyglycol ether has an average degree of ethoxylation of 6-8.

9. The cleaning composition of claim 8, wherein the C12/16 fatty alcohol polyglycol ether has an average degree of ethoxylation of 7.

10. The cleaning formulation of claim 9, wherein the one or more biocides comprises one or more isothiazolone compounds.

11. The cleaning composition of claim 10, wherein the one or more isothiazolone compounds are selected from the group consisting of 5-chloro-2-methyl-4-isothiazolin-3-one and 2-methyl-4-isothiazolin-3-one.

12. The cleaning composition of claim 9, wherein the one or more biocides comprises a mixture of 5-chloro-2-methyl-4-isothiazolin-3-one and 2-methyl-4-isothiazolin-3-one.

13. The cleaning composition of claim 12, wherein the one or more biocides comprising the biocide composition are about 1.5% of the biocide composition by weight.

14. The cleaning composition of claim 13, further comprising water, wherein the percentages of the total weight of the ingredients of the cleaning composition, excluding the citric acid, are:

| | Percentage |
|---|---|
| water | 50%-80% |
| alkyl polyglucosides | 10%-40% |
| fatty alcohol polyglycol ethers | 1%-20% |
| xanthan gum | .01%-2% |
| biocide composition | .01%-2% |

and wherein the citric acid is present in a sufficient amount to cause the cleaning composition to have the pH of 6.5-7.5.

15. The cleaning composition of claim 14, wherein the percentages of the total weight of the ingredients of the cleaning composition, excluding the citric acid, are:

| | Percentage |
|---|---|
| water | 60%-65% |
| alkyl polyglucosides | 20%-25% |
| fatty alcohol polyglycol ethers | 10%-15% |
| xanthan gum | .01%-.05% |
| biocide composition | .01%-.05% |

16. The cleaning composition of claim 15, wherein the percentages of the total weight of the ingredients of the cleaning composition, excluding the citric acid, are:

| | Percentage |
|---|---|
| water | 64.4% |
| alkyl polyglucosides | 23.7% |
| fatty alcohol polyglycol ethers | 11.8% |
| xanthan gum | .05% |
| biocide composition | .05% |

17. A cleaning composition comprising the cleaning composition of claim 16 diluted with a dilutant in the ratio of 2:128.

18. A method of cleaning an article comprising contacting the cleaning composition of claim 1 with the article.

19. A method of cleaning an article comprising contacting the cleaning composition of claim 16 with the article.

20. A method of cleaning an article comprising contacting the cleaning composition of claim 17 with the article.

21. A cleaning composition comprising:
water;
an alkyl polyglucoside composition comprising about 48%-52% by weight of a mixture of C8/10 and C10/16 alkyl polyglucosides having an average degree of polymerization of 1.5 and about 48% to 52% of additional water;
a C12/16 fatty alcohol polyglycol ether having an average degree of ethoxylation of 7;
xanthan gum;
a biocide composition comprising about 1.5% by weight of a mixture of 5-chloro-2-methyl-4-isothiazolin-3-one and 2-methyl-4-isothiazolin-3-one; and
citric acid, wherein the cleaning composition comprises, by weight, and excluding the citric acid, 40.4% water, 47.4% of the alkyl polyglucoside composition comprising about 48%-52% by weight of a mixture of C8/10 and C10/16 alkyl polyglucosides having an average degree of polymerization of 1.5 and about 48% to 52% of additional water, 11.8% of the C12/16 fatty alcohol polyglycol ether having an average degree of ethoxylation of 7, 0.05% by weight of the xanthan gum, and 0.05% by weight of the biocide composition, wherein the cleaning composition has a pH of 6.5-7.5, and wherein the citric acid is present in a sufficient amount to cause the cleaning composition to have the pH of 6.5-7.5.

22. A cleaning composition comprising the cleaning composition of claim 21 diluted with a dilutant in the ratio of 2:128.

23. A method of cleaning an article comprising contacting the cleaning composition of claim 21 with the article.

24. A cleaning composition kit comprising the cleaning composition of claim 1 and written instructions to dilute the cleaning composition with water in the ratio of about 2:128.

25. A cleaning composition kit comprising the cleaning composition of claim 21 and written instructions to dilute the cleaning composition with water in the ratio of about 2:128.
